(19) United States
(12) Patent Application Publication
(10) Pub. No.: US 2012/0081518 A1
(43) Pub. Date: Apr. 5, 2012

(54) METHOD FOR 3-DIMENSIONAL MICROSCOPIC VISUALIZATION OF THICK BIOLOGICAL TISSUES

(76) Inventors: Yuan-An Liu, Hsinchu City (TW); Ann-Shyn Chiang, Hsinchu City (TW); Shiue-Cheng Tang, Hsinchu City (TW)

(21) Appl. No.: 13/244,297

(22) Filed: Sep. 24, 2011

(30) Foreign Application Priority Data
Oct. 1, 2010 (TW) 099133619

(51) Int. Cl. H04N 13/02

(52) U.S. Cl. 348/46; 348/E13.074

(57) ABSTRACT

The present invention discloses a method of visualizing the 3-dimensional microstructure of a thick biological tissue. This method includes: a process of immersing thick, opaque biological tissues in the optical-clearing solution, for example FocusClear (U.S. Pat. No. 6,472,216), and utilizing an optical scanning microscope and a cutter. In microscopy, the cutter removes a portion of the tissue after each round of optical scanning. Each round of optical scanning follows the principal that the depth of the removal plane is less than the depth of the boundary plane derived from the scanning This method acquires an image stack to provide the information of thick biological tissue's 3-dimensional microstructure with minimal interference by the tissue removal.

### CROSS-REFERENCE TO RELATED APPLICATIONS

This application claims the benefit of TAIWAN Patent Application Ser. No. 099133619, filed on Oct. 1, 2010, which are herein incorporated by reference.

### TECHNICAL FIELD

This invention relates generally to a method of visualizing a 3-dimensional structure of a thick biological tissue, and more particularly to a method of combining the optical-clearing process (use of immersion solution to reduce random scattering as light travels across media), confocal microscopy, and controlling tissue removal to visualize the 3-dimensional microstructure of a tissue block such as the endoscopic biopsy.

### BACKGROUND OF THE RELATED ART

Three-dimensional (3D) microscopic visualization of tissue of interest is crucial in biomedical research. For example, 3D visualization of a suspicious area of the patient's biopsy provides a global view of the tissue organization. This feature is particularly valuable when intricate vascular and neural networks are the prime targets for inspection. Although the microtome-based 2-dimensional (2D) histology is the current standard method for tissue analysis, diagnostic errors and inconclusive results are embedded in the process due to incomplete sampling—only a few sections of the specimen are examined to represent the bulk tissue. Alternatively, biological tissues can be treated with an optical-clearing solution, such as the disclosed FocusClear solution (U.S. Pat. No. 6,472,216; Taiwan R.O.C patent 206390) for deep-tissue microscopy. The optical-clearing process is to immerse the tissue in the optical-clearing solution, which has a high refractive index, to reduce light scattering. For example, the application of the FocusClear solution (refractive index: 1.46) reduces the amount of refractive mismatch between tissue constituents (high refractive index, ˜1.46) and fluids (low refractive index; water has a refractive index at 1.33), therefore avoiding random scattering and making biological tissues transparent to facilitate laser penetration and fluorescence detection. Particularly, optical clearing is compatible with optical sectioning microscopy, such as confocal microscopy, which acquires optical slices from thick tissue specimens by excluding the out-of-focus signals from the focal plane, allowing 3D reconstruction of the acquired image stack. Combining the optical-clearing method and optical sectioning microscopy can significantly increase the imaging depth.

However, because optical clearing only reduces scattering, the limitation of the imaging depth is relaxed but still exists at the range ˜300 μm. For animal tissue of large size, such as human or mouse, this imaging depth cannot provide the field (or depth) for 3D characterization of the structure of interest at the centimeter level. Thus, it is crucial to devise an add-on to the disclosed FocusClear patent to extend the current image acquisition method.

Accordingly, there is still a need for a solution to enhance the imaging depth of optical-cleared biological tissues.

### SUMMARY

The present invention discloses a method for 3-dimensional microscopic visualization of thick biological tissues. This method includes: providing a thick biological tissue which is processed by an aqueous optical-clearing solution so as to allow light to travel across the thick biological tissue, providing a removal apparatus (or a cutter) to remove a portion of the thick biological tissue, using an image capturing apparatus to capture the image of a surface of the thick biological tissue, increasing a focal depth of the image capturing apparatus incrementally so as to capture the image stack from surface of the thick biological tissue to the boundary plane which is defined as the limitation of the imaging depth (the limitation is defined by the user according to required imaging quality of the user, because biological tissues scatter light, the resolution of the acquired image will be too low to satisfy user's demand of image quality when the focal path moves beyond the depth limitation), defining a removal plane above the boundary plane, executing a tissue removal to remove the thick biological tissue above removal plane which is the scattering source by using the removal apparatus, and increasing the focal depth to capture images of the thick biological tissue deeper than the boundary plane.

In one embodiment, the image capturing apparatus includes confocal microscopy, multi-photon laser scanning microscopy, and other optical sectioning microscopy. The optical-clearing solution includes FocusClear which was disclosed in U.S. Pat. No. 6,472,216. The thick biological tissue includes animal tissues, plant tissues, artificial tissues, or biomaterial tissues. The removal apparatus includes mechanical slicer, laser cutter, chemical erosion, or cauterization.

The removal plane is defined upper than the boundary plane or closer to the objective lens than the boundary plane (i.e. the depth of the removal plane is less than the depth of the boundary plane). The boundary plane is defined by the user according to the acquired image quality. The depth between the removal plane and the surface is less than the depth between the boundary plane and the surface. The distance between the boundary plane and the removal plane should be judged by user so as to prevent tissue under the boundary plane from distortion enforced by the tissue removal.

A plurality of tissue removal rounds is executed and each round follows the principal that the depth of the removal plane is less than the depth of boundary plane. This method acquires an image stack to provide the information of tissue's 3-dimensional microstructure with minimal interference from tissue sectioning as confronted by the conventional histological method.

### BRIEF DESCRIPTION OF THE DRAWINGS

The above objects, and other features and advantages of the present invention will become more apparent after reading the following detailed description when taken in conjunction with the drawings, in which:

FIG. 1 illustrates a thick biological tissue, which is placed on a scanning stage and is virtually divided into a shallow portion which can be visualized after optical clearing (which is within the limitation of the focal depth) and a deep portion which is the rest of the tissue. The boundary between these two portions is defined as boundary plane.

FIG. 2a illustrates the shallow portion of the thick biological tissue is scanned incrementally from the surface of the thick biological tissue to the boundary plane by an image acquisition device such as a confocal microscope. Then, a removal plane is defined. The first image stack of the thick biological tissue is acquired after the scanning process.

FIG. 2b illustrates the first round of tissue removal of the thick biological tissue is executed and a new shallow portion is defined following the illustration in FIG. 1.

### DETAILED DESCRIPTION

The present invention will be described in detail using the following embodiments and it will be recognized that those descriptions and examples of embodiments are used to illustrate but not to limit the claims of the present invention. Hence, other than the embodiments described in the following, the present invention may be applied to the other substantially equivalent embodiments.

A method for visualizing the 3-dimensional microstructure of a thick biological tissue is disclosed in present invention. This method includes: utilizing a technique to increase the imaging depth of a tissue, scanning and capturing images of the tissue within the boundary plane where the limitation of imaging depth occurs, defining a removal plane upper than the boundary plane, and removing the tissue above the removal plane. Because the source of light scattering is largely reduced by tissue removal, the second round of imaging acquisition can be performed to extend the imaging depth to new boundary plane. Furthermore, removal of tissue upper than the boundary plane prevents the distortions caused by removal of tissue from interfering next round of imaging acquisition. Executing several rounds of the foregoing method, the thickness of biological tissues being visualized can be systematically increased, thus overcoming the depth limitation imposed by the conventional imaging approach.

The present invention discloses a method for observing the 3-dimensional microstructure of a thick biological tissue. In one embodiment, a thick biological tissue labeled by a fluorescent material is embedded and fixed in a gel. After immersing the opaque thick biological tissue in an optical-clearing solution, such as FocusClear (U.S. Pat. No. 6,472,216), the thick biological tissue 10 with thickness D (ex. about 600 μm) is placed on a scanning stage 20, as shown as in FIG. l. In one embodiment, the thick biological tissue includes animal tissues, plant tissue, artificial tissues, and biomaterial tissues. The technique of FocusClear was disclosed in U.S. Pat. No. 6,472,216, so the detail theory of FocusClear will not be described in the present invention. An image capturing apparatus 40, such as confocal microscopy, or multi-photon laser scanning microscopy, is employed to scan the thick biological tissue 10 and to capture image stack of the biological tissue incrementally.

In one embodiment, a laser 30 of the confocal microscopy 40 first scans the surface 1001 of the thick biological tissue 10 and then subsequently increases the focal depth of the confocal microscopy 40 incrementally to scan the tissue under the surface 1001, thereby capturing tissue images at different depths. The captured images are stacked to reconstruct a 3-dimensional image of the thick biological tissue 10. Because the tissue scatters the excitation and emission light travelling in the specimen, the deeper the scanning depth is, the worse the image definition will be.

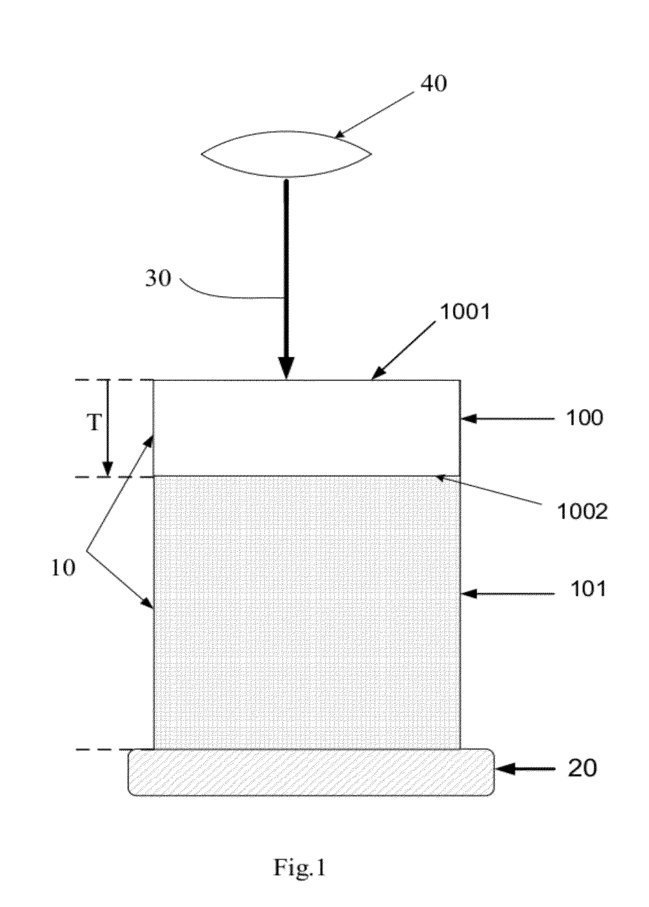

As shown in FIG. 1, in the condition that clear images can be captured when the focal depth is less than that of the plane 1002: this is T (ex. 200 μm), under the surface 1001 of the thick biological tissue 10. Images of the thick biological tissue 10 can not be correctly analyzed once the focal depth exceeds the limitation, in which the plane 1002 is defined as the boundary plane. In one embodiment, the boundary plane is judged by the user to meet the demand of image resolution. The thick biological tissue 10 above the boundary plane 1002, from the boundary plane 1002 to the surface 1001, is the shallow portion 100, of which images can be captured clearly; the thick biological tissue 10 below the boundary plane 1002, from the boundary plane 1002 to the scanning stage 20, is the deep portion 101, of which images can not be clearly analyzed.

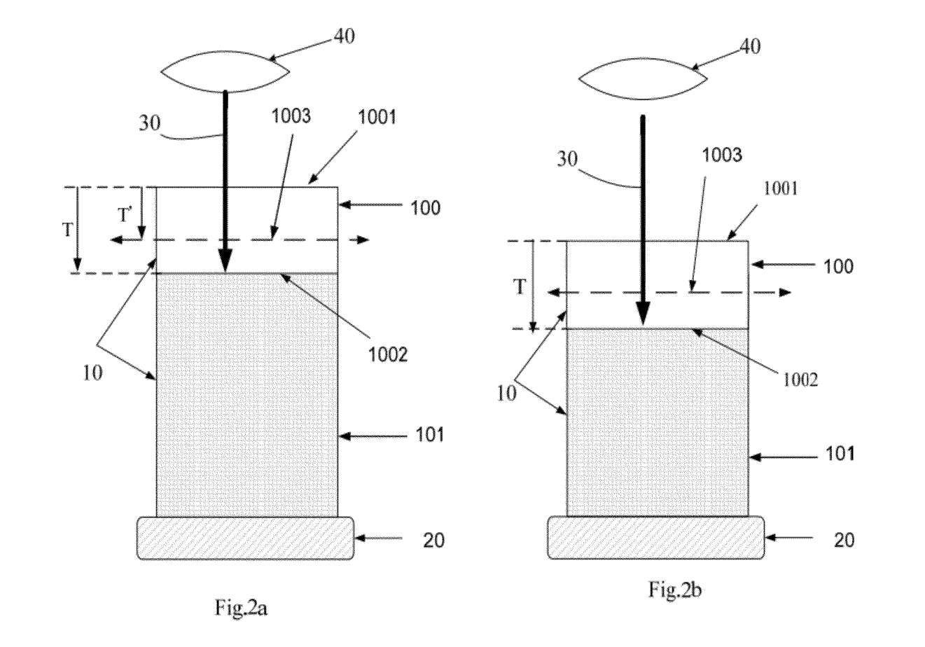

Next, a removal apparatus, such as mechanical slicer, laser cutter, chemical erosion, or cauterization, is used to remove part of the shallow portion 100 of the thick biological tissue 10 above the plane 1003 which is defined as removal plane, as shown in FIG. 2a, with the depth T′ (ex. 150 μm) under the surface 1001. The depth of the removal plane 1003, i.e., T′, has to be less than the depth of the boundary plane 1002, i.e., T. In this example, the depth of the removal plane 1003 is 150 μm, which is less than the depth of the boundary plane 1002, i.e., 200 μm. Prior to removing the thick biological tissue 10 above the removal plane 1003, images of the shallow portion 100 of the thick biological tissue 10 have already been completely captured. Thus the consequent damage on the cutting surface caused by tissue removal does not interfere with subsequent image acquisition of the thick biological tissue 10.

As shown in FIG. 2b, after the first round of the tissue removal, a new surface 1001 appears on the remaining thick biological tissue 10, and similarly a new shallow portion 100 with the depth T (ex. 200 μm) is identified as well. As it was described above, images of the new shallow portion 100 of the thick biological tissue 10 can be captured clearly and a new removal plane 1003, under the new surface 1001 and with depth T′ (ex. 150 μm), is defined again. After images of the shallow portion 100 are captured, the thick biological tissue 10 above the new removal plane 1003 is removed.

After executing several rounds of the foregoing tissue removal, images of multiple layers of the thick biological tissue 10 can be stacked to reconstruct a 3-dimensional image of the thick biological tissue 10. Although the thick biological tissue 10 experiences a plurality of cuttings (or removals), they do not interfere with the capture of tissue images because images of the shallow portion 100 are taken before the tissue removal is executed. Therefore, the reconstructed image is an intact 3-dimensional image of the thick biological tissue 10.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A method for 3-dimensional microscopic visualization of thick biological tissues, which comprises:
providing a thick biological tissue which is processed by an optical-clearing solution so as to allow light to travel across said thick biological tissue;
providing an optical scanning microscopy to capture a plurality of images of said thick biological tissue;
providing a removal apparatus to remove a portion of said thick biological tissue;
using said optical scanning microscopy to capture said images of a surface of said thick biological tissue;
defining a boundary plane under said surface of said thick biological tissue according to a predetermined image quality of said images;
increasing a focal depth of said optical scanning microscopy incrementally so as to capture said images of said thick biological tissue under said surface until said boundary plane;
defining a removal plane above said boundary plane;
executing a tissue removal to remove said thick biological tissue above said removal plane by using said removal apparatus; and
increasing said focal depth to capture images of said thick biological tissue deeper than said boundary plane.

2. The method for 3-dimensional microscopic visualization of thick biological tissues according to claim 1, wherein a depth between said removal plane and said surface is less than a depth between said boundary plane and said surface.

3. The method for 3-dimensional microscopic visualization of thick biological tissues according to claim 1, wherein said tissue removal is executed after said images of said thick biological tissue above said boundary plane are captured.

4. The method for 3-dimensional microscopic visualization of thick biological tissues according to claim 1, wherein said the optical-clearing solution includes FocusClear.

5. The method for 3-dimensional microscopic visualization of thick biological tissues according to claim 1, wherein said thick biological tissue includes animal tissues, plant tissues, artificial tissues, or biomaterial tissues.

6. The method for 3-dimensional microscopic visualization of thick biological tissues according to claim 1, wherein said removal apparatus includes mechanical slicer, laser cutter, chemical erosion, or cauterization.

7. The method for 3-dimensional microscopic visualization of thick biological tissues according to claim 1, wherein said predetermined image quality is determined by a user.

8. The method for 3-dimensional microscopic visualization of thick biological tissues according to claim 7, wherein said predetermined image quality implies that said user cannot observe said images clearly through said optical sectioning microscopy if beyond predetermined image quality.

9. A method for 3-dimensional microscopic visualization of thick biological tissues, which comprises:
providing a thick biological tissue which is processed by an optical-clearing solution so as to allow light to travel across said thick biological tissue;
providing an optical scanning microscopy to capture a plurality of images of said thick biological tissue;
providing a removal apparatus to remove a portion of said thick biological tissue;
executing a plurality of rounds, of which each round defines said boundary plane, said removal plane, and executes said tissue removal according to claim 1 to capture said images of said thick biological tissue; and
stacking said images to reconstruct a 3-dimensional image of said thick biological tissue.

10. The method for 3-dimensional microscopic visualization of thick biological tissues according to claim 9, wherein a depth between said removal plane and said surface is less than a depth between said boundary plane and said surface.

11. The method for 3-dimensional microscopic visualization of thick biological tissues according to claim 9, wherein said tissue removal is executed after said images of said thick biological tissue above said boundary plane are captured.

12. A method for 3-dimensional microscopic visualization of thick biological tissues, which comprises:
providing a thick biological tissue which is processed by an optical-clearing solution so as to allow light to travel across said thick biological tissue;
providing an image capturing apparatus to capture a plurality of images of said thick biological tissue;
providing a removal apparatus to remove a portion of said thick biological tissue;
using said image capturing apparatus to capture said images of a surface of said thick biological tissue;
defining a boundary plane under said surface of said thick biological tissue according to a predetermined image quality of said images;
increasing a focal depth of said image capturing apparatus incrementally so as to capture said images of said thick biological tissue under said surface until said boundary plane;
defining a removal plane above said boundary plane;
executing a tissue removal to remove said thick biological tissue above said removal plane by using said removal apparatus; and
increasing said focal depth to capture images of said thick biological tissue deeper than said boundary plane.

13. The method for 3-dimensional microscopic visualization of thick biological tissues according to claim 12, wherein said image capturing apparatus includes confocal microscopy, multi-photon laser scanning microscopy, and optical sectioning microscopy.

14. The method for 3-dimensional microscopic visualization of thick biological tissues according to claim 12, wherein a depth between said removal plane and said surface is less than a depth between said boundary plane and said surface.

15. The method for 3-dimensional microscopic visualization of thick biological tissues according to claim 12, wherein said tissue removal is executed after said images of said thick biological tissue above said boundary plane are captured.

16. The method for 3-dimensional microscopic visualization of thick biological tissues according to claim 12, wherein said an optical-clearing solution includes FocusClear.

17. The method for 3-dimensional microscopic visualization of thick biological tissues according to claim 12, wherein said thick biological tissue includes animal tissues, plant tissues, artificial tissues, or biomaterial.

18. The method for 3-dimensional microscopic visualization of thick biological tissues according to claim 12, wherein said removal apparatus includes mechanical slicer, laser cutter, chemical erosion, or cauterization.

19. The method for 3-dimensional microscopic visualization of thick biological tissues according to claim 12, wherein said predetermined image quality is determined by a user.

20. The method for 3-dimensional microscopic visualization of thick biological tissues according to claim 19, wherein said predetermined image quality implies that said user cannot observe said images clearly through said image capturing apparatus if beyond said predetermined image quality.
